(19) United States
(12) Patent Application Publication
(10) Pub. No.: US 2024/0347839 A1
(43) Pub. Date: Oct. 17, 2024

(54) Drive Battery for a Motor Vehicle and Motor Vehicle Having a Drive Battery of This Kind

(71) Applicant: Bayerische Motoren Werke Aktiengesellschaft, Muenchen (DE)

(72) Inventors: Savo ASANIN, Muenchen (DE); Nicolas FLAHAUT, Muenchen (DE); Thomas HARSCH, Muenchen (DE); Thomas HERRMANN, Illerkirchberg (DE); Daniel MECKL, Hallbergmoos (DE); Martin MITTERMAIER, Muenchen (DE); Julian PATSCHEIDER, Muenchen (DE); Alexander RHEINFELD, Muenchen (DE); Moritz RITTEREISER, Muenchen (DE); Peter ROESCH, Muenchen (DE); Hadar SLEIMAN, Muenchen (DE); Stefan ULLRICH, Pfaffenhofen an der Ilm (DE); Paul WINKLER, Muenchen (DE)

(21) Appl. No.: 18/290,981

(22) PCT Filed: Sep. 2, 2021
(86) PCT No.: PCT/EP2021/074260

§ 371 Date: Jan. 22, 2024

(30) Foreign Application Priority Data
Jul. 23, 2021 (DE) 10 2021 119 194.7

(51) Int. Cl. H01M 50/249; B60L 50/60; B60L 50/64; H01M 50/213

(52) U.S. Cl. CPC H01M 50/249; B60L 50/64; B60L 50/66; H01M 50/213

(57) ABSTRACT

A drive or traction battery for a motor vehicle has a battery housing with a top wall and a bottom wall. The bottom wall forms, at least in part, an underbody of the motor vehicle. In the battery housing there is a battery cell layer having a plurality of battery cells, arranged vertically and next to one another, and a support layer, which can also be referred to as a degassing layer, spacer layer, collision protection layer or deformation layer. In each battery cell, at least one degassing opening is formed in the side facing the support layer, and a degassing space, such as a recess, that can hold a certain volume of gas is arranged opposite each degassing opening in the support layer.

### BACKGROUND AND SUMMARY

The present invention relates to a traction battery for a motor vehicle with a traction battery housing.

A motor vehicle with electric drive usually has a traction battery which has a traction battery housing, in which a plurality of battery modules with battery cells, an electrical/electronics system and a cooling device are mounted. The traction battery housing is in turn mounted below a floor assembly on a vehicle body. The known traction battery housing consists, for example, of aluminum and has lateral beams, a cover and a floor. The lateral beams are configured, for example, as extruded profiles or cast parts. Further longitudinal beams and crossmembers are also possibly provided in the battery housing, in order to impart a certain rigidity and collision resistance capability to the traction battery.

As is shown in DE 10 2017 223 407 A1, a known traction battery housing has longitudinal beams and a plurality of crossmembers which run between the longitudinal beams. Furthermore, the traction battery housing has an upper wall and a lower wall which are each connected at least to an outer beam structure, that is to say to the outer longitudinal beams and the outer crossmembers. The longitudinal beams and also the crossmembers are configured from extruded profiles. The traction battery housing is mounted below a vehicle body floor.

It is the object of the present invention to provide a traction battery and a motor vehicle with a traction battery of this type, the traction battery forming an undertray of the motor vehicle and, in the case of a flat overall design, both making degassing of battery cells possible and protecting the battery cells in an improved manner in the case of a collision with the ground.

This object is achieved by way of a traction battery, and a motor vehicle having such a traction battery, which have the features of the independent claims. Advantageous refinements of the invention are specified in the dependent claims.

According to the invention, the traction battery for a motor vehicle has a traction battery housing which has a top wall and a bottom wall. The bottom wall at least partially configures an undertray of the motor vehicle. A battery cell layer, with a multiplicity of battery cells which are arranged vertically and next to one another, and a supporting layer, which can also be called a degassing layer, a spacer layer, a collision protection layer or a deformation layer, are arranged in the traction battery housing. At least one degassing opening is configured in each battery cell in the side which faces the supporting layer, and a degassing space, that is to say a cutout which can receive a certain gas volume, in the supporting layer lies opposite each degassing opening.

Firstly, the supporting layer establishes a certain spacing between a lower side of the bottom wall which decisively determines a ground clearance of the motor vehicle, with the result that the battery cell layer is protected in the case of a collision with the ground. In other words, in the case of driving over a bollard or the like, that is to say in the case of a collision from below, sufficient deformation space is available. Secondly, the supporting layer provides a volume by way of the degassing openings, into which volume escaping gas of a degassing, defective battery cell can be conducted. The degassing openings of the battery cells are oriented downward and not in the direction of the top wall and therefore of a passenger compartment in the installed state of the traction battery. As a result, gases can be conducted away from the passenger compartment in an improved manner.

The supporting layer is advantageously adhesively bonded, in particular by means of a lowermost adhesive layer, to the bottom wall and is adhesively bonded, in particular by means of an upper adhesive layer, to the battery cell layer, in particular over a large area, that is to say substantially over its entire respectively adjoining surface. Furthermore, the battery cell layer can be adhesively bonded, in particular by means of an uppermost adhesive layer, to the top wall, in particular over a large area.

The battery cell layer is adhesively bonded, in particular by means of an upper adhesive layer, to the top wall and is adhesively bonded, in particular by means of a lower adhesive layer, to the supporting layer, in particular over a large area, that is to say over its entire surface. Furthermore, the supporting layer is adhesively bonded, in particular by means of a further adhesive layer, to the bottom wall. Overall, therefore, the traction battery is of sandwich-like construction, the bottom layer and the top layer forming the outermost layers, and the battery cell layer and the supporting layer forming the inner layers.

As a result, a traction battery is provided which saves installation space and is highly compact in the vertical direction, that is to say in the Z-direction in the vehicle coordinate system. In relation to the overall height of the traction battery, the battery cells can be of relatively high configuration, as a result of which storage capacity of the traction battery is increased. As a result of the sandwich-like adhesive bonding of the top wall, the battery cell layer, the supporting layer and the bottom wall to one another, the traction battery overall has a high torsional and flexural rigidity, with the result that no further carrier construction is required within the traction battery. All the layers of the traction battery contribute to a rigidity and strength of the traction battery. The traction battery is configured for installation into the motor vehicle in such a way that the top wall is configured at the top and the bottom wall is configured at the bottom. Therefore, in the installed state, the bottom wall preferably configures an undertray of the motor vehicle. As a result of the adhesive bonding of the supporting layer, it contributes to rigidity and strength of the traction battery despite its deformation capability.

Each degassing opening is advantageously assigned precisely one degassing space. The spacer layer, however, can have degassing spaces which are assigned to a plurality of or an entire row of degassing openings.

Each degassing space can be configured by way of a blind hole (the open side of the blind hole lying opposite the degassing opening) or a through hole in the supporting layer.

As a result, the supporting layer with the degassing spaces can be produced simply.

A diameter of a degassing space is preferably smaller than a diameter of a battery cell.

Each degassing space can particularly advantageously be connected in terms of flow at least to a further adjacent degassing space, in particular via a degassing channel.

As a result, the volume of a plurality of degassing spaces can be utilized to receive gas if gas exits from an individual battery cell.

It is even more advantageous here if a degassing space is connected in terms of flow at least to two adjacent degassing spaces, for example also three, four, five or six adjacent degassing spaces, in particular via corresponding degassing channels. A degassing space is preferably connected in terms of flow to four adjacent degassing spaces, in particular via degassing channels.

The fluidic connection, in particular the degassing channel or the degassing channels, can be configured by way of at least one groove in the supporting layer, or a plurality of grooves can be configured in the supporting layer.

As a result, the fluidic connections in the supporting layer can be produced simply.

The fluidic connection, in particular the degassing channel or the degassing channels, is preferably configured on a side of the supporting layer which faces the battery cell layer.

As an alternative or in addition, the fluidic connection, in particular the degassing channel or the degassing channels, can be configured on a side of the supporting layer which faces the bottom wall. As a result, a supporting area which is as great as possible of the supporting layer on the battery cell layer can be provided on the side which faces the battery cell layer. As a result, furthermore, the hot gas is advantageously conducted further at a distance from the battery cell layer.

In accordance with one preferred development, the supporting layer can be configured from a structural foam, in particular an expanded polypropylene or a polyurethane foam.

A structural foam of this type is light, the supporting layer can be produced simply from it, and the structural foam has satisfactory deformation and energy absorption properties. Furthermore, a large-area supporting surface for the battery cell layer can be provided by way of the structural foam.

The structural foam is preferably of closed-cell configuration.

The structural foam preferably has thick-walled structures in the vehicle vertical direction which is preferably configured congruently with respect to a structure of the battery cell layer.

As an alternative to a structural foam, the supporting layer can be configured from an injection molded plastic part. The supporting layer can likewise be configured by plastic extrusion, that is to say as an extruded plastic part.

An injection molded plastic part can be simply produced in a large number inexpensively. This also applies to plastic extrusion.

Here, the injection molded plastic part or the extruded plastic part can have thin-walled structures in the vehicle vertical direction which is preferably configured congruently with respect to a structure of the battery cell layer.

The thin-walled structures can preferably be of cup-shaped configuration, the open side of the cup shape facing, in particular, the degassing opening.

As an alternative, the thin-walled structures can also be of undulating configuration, an undulation trough in each case facing a multiplicity of degassing openings which, in particular, lie in a line.

The battery cell layer is preferably configured from a multiplicity of battery cells, each battery cell consisting of a battery cell housing with a battery cell housing shell, a battery cell housing bottom and a battery cell housing top, in which a cell winding is received. The degassing opening which can also be called a degassing valve is preferably configured in the battery cell housing bottom. Here, the battery cell housing bottom and the battery cell housing top are preferably adhesively bonded to the adjacent layers, the top wall and the supporting layer. The battery cell housings are preferably configured in a thin-walled manner and from metal, for example aluminum or steel. Adjacent battery cell housings among one another can be adhesively bonded to one another on the shell surface. The battery cell can be what is known as a round cell, that is to say circular-cylindrical, or can also be what is known as a prismatic cell, that is to say substantially cuboid.

As an alternative, the battery cell layer can also have a multiple chamber structure with a multiplicity of vertical chambers, in which in each case one or a plurality of cell windings are received. The multiple chamber structure can be produced, for example, by way of extrusion. The individual chambers can have a square or other polygonal cross section, for example similar to honeycombs.

In accordance with one development, the supporting layer can be configured in one piece at least in the vertical direction. A plurality of separately configured, single-piece supporting layer elements can be arranged over an entire surface area of the battery cell layer so as to adjoin one another. In one piece in the vertical direction means that the supporting layer itself does not consist of a plurality of layers which are arranged above one another.

The supporting layer can be of structurally effective configuration and can increase a rigidity and strength of the traction battery.

The supporting layer is preferably configured to dissipate collision energy by way of deformation in the case of a collision of the bottom wall.

As a result, the battery cell layer can be protected against the collision energy.

As an alternative or in addition, the supporting layer can be configured for a large-area distribution of a collision load to the battery cell layer for the case of a collision of the bottom wall.

A distribution of the collision load decreases a load which acts on individual battery cells.

The top wall and the bottom wall are preferably connected to one another via a flange connection. Here, a fluid-tight traction battery housing can be configured by way of a corresponding seal, for example on the flange connection. For this purpose, the top wall and/or the bottom wall can be of tub-shaped configuration or can be a constituent part of a tub.

The top wall and/or the bottom wall can consist of aluminum or an aluminum alloy or of steel. The top wall and/or the bottom wall can also consist, however, of a fiber-reinforced plastic, for example a carbon fiber-reinforced plastic.

A further aspect of the invention relates to a motor vehicle, in particular a passenger motor vehicle or a heavy goods vehicle, with a traction battery as described above.

The motor vehicle has an electric drive. A vehicle body of the motor vehicle has, for example, a floor assembly with a left-hand longitudinal beam and a right-hand longitudinal beam. Vehicle body longitudinal beams of this type are also called side sills or outer, lower longitudinal beams. The traction battery is preferably mounted from below on the floor assembly. The traction battery configures an undertray of the motor vehicle at least in sections. Furthermore, the mounted traction battery can configure a floor of the floor assembly, that is to say a floor of the passenger cell, at least in sections. The traction battery advantageously extends substantially over an entire width of the floor assembly, that is to say substantially over an entire installation space between the left-hand longitudinal beam and the right-hand longitudinal beam. Furthermore, the traction battery housing can extend in a region or over as great a region as possible between a front axle and a rear axle of the motor vehicle. The traction battery housing advantageously extends from a front end wall (of a passenger cell) or from below the front end wall as far as front ends of a left-hand wheel arch and a right-hand wheel arch. Furthermore, the traction battery housing can extend as far as below a second seat row of the motor vehicle. In other words, the traction battery housing can extend at least from a region between a front vehicle body pillar (an A-pillar) and a rear vehicle body pillar (in particular, a C-pillar).

Further developments of the invention listed above can be combined as desired with one another in so far as this is possible and useful.

A brief description of the figures follows.

### BRIEF DESCRIPTION OF THE DRAWINGS

FIG. 1 diagrammatically shows a sectional view of a traction battery in accordance with one exemplary embodiment of the present invention.

FIG. 2 shows a diagrammatic perspective view of a supporting layer of the traction battery from below in accordance with the exemplary embodiment of the present invention.

FIG. 3 shows a diagrammatic perspective view of the supporting layer of the traction battery from above in accordance with the exemplary embodiment of the present invention.

FIG. 4 shows a diagrammatic perspective view of the supporting layer of the traction battery from below in accordance with a further exemplary embodiment of the present invention.

FIG. 5 diagrammatically shows a perspective view of a motor vehicle with a vehicle body and the traction battery before mounting of the traction battery on the vehicle body in accordance with the exemplary embodiment of the present invention.

### DETAILED DESCRIPTION OF THE DRAWINGS

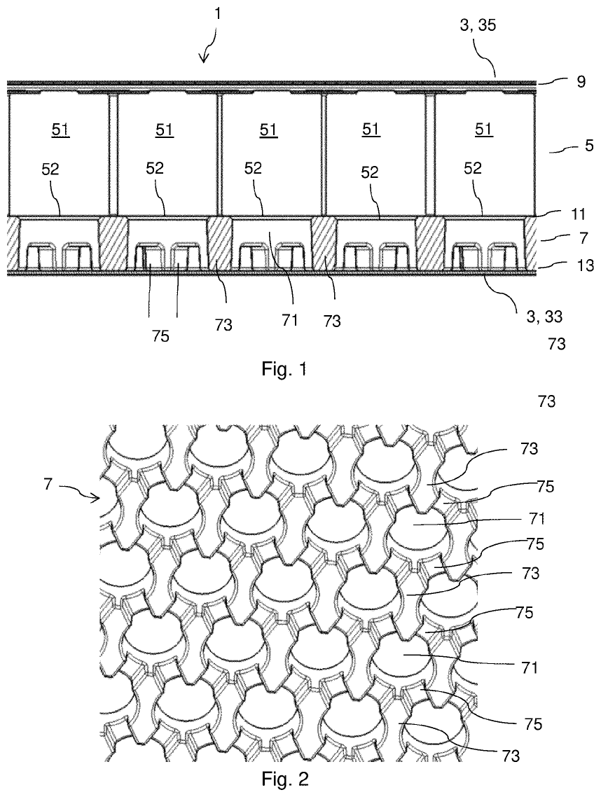

A description of exemplary embodiments of the present invention follows with reference to FIGS. 1 to 5.

FIG. 1 diagrammatically shows a traction battery 1 in accordance with one exemplary embodiment of the present invention in a sectional view. The traction battery 1 is configured for mounting on a vehicle body 100 of a passenger motor vehicle. The traction battery 1 is what is known as a high voltage accumulator for driving an electric drive motor of the passenger motor vehicle. The traction battery 1 is constructed in a sandwich-like manner from a plurality of layers. Beginning from the top, the traction battery 1 has a top wall 35 as part of a traction battery housing 3. The top wall 35 is connected over the full area via an uppermost adhesive layer to an upper side of a battery cell layer 5. Furthermore, a lower side of the battery cell layer 5 is connected over the full area via an upper adhesive layer to a supporting layer 7. The supporting layer 7 is in turn connected on its lower side via a lower adhesive layer 13 to a bottom wall 33 of the traction battery housing 3. The top wall 35 and the bottom wall 33 are connected to one another at the edges of the traction battery housing 3 via a flange connection 39 (not shown in FIG. 1).

The battery cell layer 5 consists of a multiplicity of battery cells 51. Each battery cell 51 in turn consists of a battery cell housing made from aluminum or steel, in which a cell winding is received. The battery cells 51 are what are known as round cells with a circular-cylindrical shape. The battery cells 51 are arranged upright, that is to say vertically, in the battery cell layer 5, with the result that they adjoin one another with their shell surfaces. The upper end sides of the battery cells 51 are each connected to the adhesive layer 9 and therefore to the top wall 35. The lower end sides of the battery cells 51 are each connected to the adhesive layer 11 and therefore to the supporting layer 7.

A battery cell contacting system (not shown in further detail) which connects the poles of the battery cells 51 suitably to one another is embedded into the adhesive layer 9. The adhesive surrounds conductor tracks of the battery cell contacting system. Both poles of the battery cells 51 are situated on the upper end side of the battery cells 51.

Degassing openings 52 are configured on the lower end side of the battery cells 51. Cutouts or degassing spaces 71 are configured in the supporting layer 7 in a complementary manner with respect to the degassing openings of the battery cells 51. The degassing spaces 71 are connected to one another suitably via degassing channels 75, with the result that gas which escapes from a battery cell 51 can be discharged via the degassing channels 75 of the supporting layer 7. As can be seen, the degassing channels 75 are configured on a side of the supporting layer 7 which faces the bottom wall 33. Wide walls 73 are situated between the degassing spaces 71. The battery cells 51 bear against the walls 73. In particular, the walls 73 are of complementary configuration with respect to the edges of the battery cells 51, with the result that the walls 73 can be supported on the battery cells 51 as desired.

The supporting layer 7 consists of a foamed polyurethane and is deformable. In the case of a ground collision of the traction battery 1 which is installed into the motor vehicle, the bottom wall 33 is possibly deformed here together with the supporting layer 7, and can therefore absorb collision energy by way of deformation in order to protect the battery cell layer 5.

FIG. 2 shows the supporting layer 7 in a perspective view from below. The degassing spaces 71 are configured as through holes in the supporting layer 7. As can be seen clearly in the perspective view, furthermore, the degassing channels 75 are grooves on the lower side of the supporting layer 7. Each degassing space 71 (with the exception of degassing spaces which are not shown at the edges of the supporting layer) is connected via four degassing channels 75 to four of six adjacent degassing spaces 71. It would also be possible to connect a degassing space 71 to all the degassing channels 75; in the way shown in the exemplary embodiment, however, it is also possible for the gas stream to be channeled in a certain direction (upward and downward in FIG. 2).

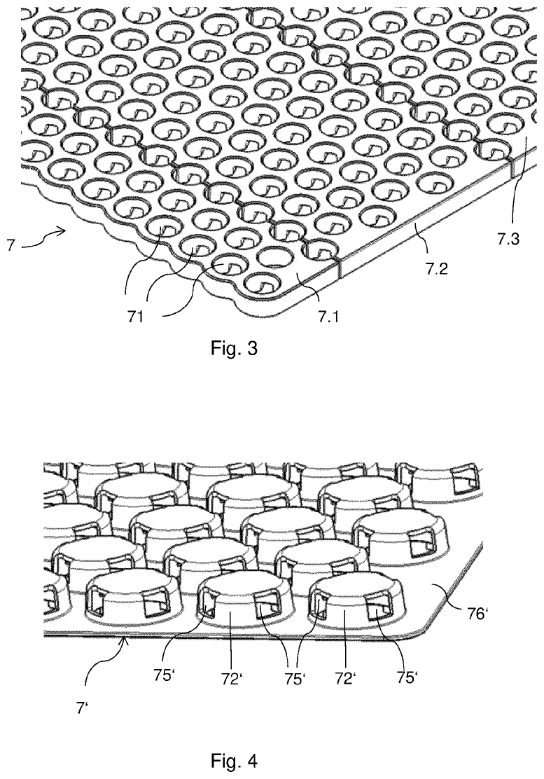

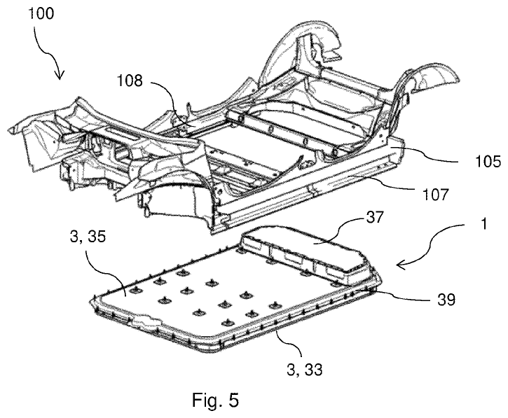

FIG. 3 shows the supporting layer 7 in a perspective view from above. The upper side of the supporting layer 7 which is supported on the battery cell layer 5 can therefore be seen. It can be seen, in particular, that the upper side of the supporting layer 7 configures a substantially planar surface with the through holes (degassing spaces 71) which are arranged regularly, in accordance with the battery cells 51, and therefore configures a large-area supporting surface for battery cells 51 of the battery cell layer 5. Furthermore, two edges of the supporting layer 7 which is substantially rectangular in accordance with the shape of the traction battery 1 (as shown in FIG. 5) are also shown. The supporting layer 7 consists of a plurality of supporting layer elements 7.1, 7.2, 7.3 which are produced separately and are arranged so as to adjoin one another. The respective supporting layer elements 7.1, 7.2, 7.3 are produced in one piece from the foam material.

In the case of an exit of gas from a battery cell 51, the gas which is as a rule very hot can then be forwarded easily via the associated degassing space 71 to adjacent degassing spaces and so on.

In the case of a collision from below, for example driving over a bollard, the supporting layer 7 forms a deformation layer which can dissipate collision energy sufficiently by means of deformation, without this collision energy having a disadvantageous effect on the battery cells. Furthermore, the possibly spatially limited collision load is distributed over a large area by way of the sandwich-like construction of the traction battery and the large-area support of the supporting layer 7 on the battery cell layer 5, with the result that the load which acts on an individual battery cell 51 is advantageously decreased. The collision load is distributed to a large number of battery cells 51.

FIG. 4 shows a further exemplary embodiment of a supporting layer 7′ in a perspective view from below. The supporting layer 7′ in accordance with the further exemplary embodiment is produced by means of plastic injection molding. The supporting layer 7′ has a base plate 76′, on which a multiplicity of thin-walled cups 72′ which in turn have degassing openings 75′ as fluidic connections according to the invention are configured. A bottom of the cups 72′ adjoins the bottom wall 33 of the traction battery 1 and is adhesively bonded to the bottom wall. An open side of the cups 72′ is configured integrally with the base plate 76′. Accordingly, as viewed from above, the base plate 76′ has a multiplicity of blind holes (degassing spaces 71), in a similar manner to the illustration of the exemplary embodiment in FIG. 3.

The effect and function of the supporting layer 7′ in accordance with the further exemplary embodiment is analogous to the above-described exemplary embodiment.

FIG. 5 shows the state before mounting of the traction battery 1 on a vehicle body 100. The vehicle body 100 is not shown completely in FIG. 1, but rather substantially only a floor assembly 105 of the vehicle body 100. The vehicle body 100 or the floor assembly 105 has a left-hand side sill 107 and a right-hand side sill 108, that is to say longitudinal beams. The traction battery 1 has a traction battery housing 3 as described above which has substantially an identical height over its entire extent, with the exception of an additional housing 37 which is placed on it in the rear region of the traction battery 1. The battery cell layer 5 is accommodated in the traction battery housing 3. An electrical/electronics system of the traction battery 1 is accommodated in the additional housing 37, for example. The traction battery 1 is mounted from below on the floor assembly 105 by means of screw connections and possibly additionally by way of adhesive bonds.

The mounted traction energy accumulator housing 3 configures a floor of the floor assembly 105 at least in sections, that is to say a floor of the passenger cell, and extends over an entire width of the floor assembly 105 between the left-hand side sill 107 and the right-hand side sill 108 and from a front end wall in the region of the front wheel arches as far as a rear seat bench (not shown) which forms a second seat row, in the region of the rear wheel arches. Furthermore, the traction energy accumulator housing 3 configures an undertray of the passenger motor vehicle.

The traction battery 1 has a high flexible and torsional rigidity as a result of the sandwich-like construction of the traction battery 1 and the adhesive bonding of the layers to one another. As a result, the mounted traction battery 1 can interact correspondingly with the floor assembly 105, with the result that the motor vehicle overall has a higher flexural and torsional rigidity. In other words, the traction battery 1 can particularly satisfactorily assume a vehicle body structure function as a result of the above-described design.

Overall, the traction battery housing 3 bears sealingly against the corresponding constituent parts of the floor assembly 105, with the result that the traction battery housing 3 and the floor assembly 105 configure in an interacting manner a fluid-tight floor of the passenger cell 109 of the motor vehicle.

In comparison with a conventional floor assembly of a vehicle body, the floor assembly 105 has no floor panel and therefore clearances between the adjacent crossmembers/crossmember structures. These clearances are closed by way of the traction battery housing 3.

1.-15. (canceled)

16. A traction battery for a motor vehicle, comprising:
a traction battery housing having a top wall and a bottom wall, the bottom wall at least partially configuring an undertray of the motor vehicle;
a battery cell layer, with a multiplicity of battery cells which are arranged vertically and next to one another;
a supporting layer, wherein the battery cell layer and the supporting layer are arranged in the traction battery housing;
at least one degassing opening configured in each battery cell in a side thereof which faces the supporting layer; and
a degassing space in the supporting layer lying opposite each degassing opening.

17. The traction battery according to claim 16, wherein
the supporting layer is adhesively bonded to the bottom wall and is adhesively bonded to the battery cell layer, and
the battery cell layer is adhesively bonded to the top wall.

18. The traction battery according to claim 16, wherein
each degassing opening is assigned precisely one degassing space.

19. The traction battery according to claim 16, wherein
each degassing space is configured as a blind hole or a through hole in the supporting layer.

20. The traction battery according to claim 19, wherein
a diameter of a degassing space is less than a diameter of a battery cell.

21. The traction battery according to claim 16, wherein
each degassing space is connected in terms of flow, via a degassing channel, at least to a further adjacent degassing space.

22. The traction battery according to claim 21, wherein
a degassing space is connected in terms of flow, via corresponding degassing channels, at least to two adjacent degassing spaces.

23. The traction battery according to claim 21, wherein
a degassing space is connected in terms of flow, via corresponding degassing channels, at least to four adjacent degassing spaces.

24. The traction battery according to claim 21, wherein
the degassing channel for the flow connection is configured by way of at least one groove in the supporting layer.

25. The traction battery according to claim 21, wherein
the degassing channel for the flow connection is configured on a side of the supporting layer which faces the battery cell layer.

26. The traction battery according to claim 21, wherein
the degassing channel for the flow connection is configured on a side of the supporting layer which faces the bottom wall.

27. The traction battery according to claim 16, wherein
the supporting layer is of a structural foam.

28. The traction battery according to claim 27, wherein the structural form is an expanded polypropylene or a polyurethane foam.

29. The traction battery according to claim 16, wherein
the supporting layer is an injection molded plastic part or an extruded plastic part.

30. The traction battery according to claim 16, wherein
the supporting layer is configured in one piece at least in a vertical direction, and
a plurality of separately configured, single-piece supporting layer elements are arranged over an entire surface area of the battery cell layer so as to adjoin one another.

31. The traction battery according to claim 16, wherein
the supporting layer is structurally effective to increase a rigidity and strength of the traction battery.

32. The traction battery according to claim 16, wherein
the supporting layer is configured to dissipate collision energy by way of deformation in an event of a collision of the bottom wall, and/or
the supporting layer is configured for a large-area distribution of the collision load to the battery cell layer in the event of the collision of the bottom wall.

33. A motor vehicle comprising a traction battery according to claim 16.
